(19) United States
(12) Patent Application Publication
(10) Pub. No.: US 2009/0058968 A1
(43) Pub. Date: Mar. 5, 2009

(54) INKJET PRINT HEAD AND METHOD OF PRINTING THEREWITH

(75) Inventors: Kyu Suk LEE, Suwon-si (KR); Eun Bong Han, Suwon-si (KR); Nam Kyun Kim, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/136,883

(22) Filed: Jun. 11, 2008

(30) Foreign Application Priority Data
Sep. 4, 2007 (KR) 2007-89368

(51) Int. Cl. B41J 2/19

(52) U.S. Cl. 347/92

(57) ABSTRACT

An inkjet print head having a dummy ink chamber and a dummy heater disposed in the inkjet print head such that air bubbles gathered at edges of an ink feed hole are pushed toward an inner side of the ink feed hole when inks are sprayed. Accordingly, although air bubbles caused by the air introduced from an exterior or separated from inks are gathered at the edges of the ink feed hole, the air bubbles are forcedly pushed toward the center portion of the ink feed hole communicating with an ink storage container such that the air bubbles can flow into the ink storage container. Thus, inks are easily supplied to ink chambers adjacent to the edges of the ink feed hole, so that missing nozzles can be prevented from being generated.

### CROSS-REFERENCE TO RELATED APPLICATIONS

This application claims priority under 35 U.S.C. §119(a) from Korean Patent Application No. 2007-89368, filed on Sep. 4, 2007, in the Korean Intellectual Property Office, the disclosure of which is incorporated herein in its entirety by reference.

### BACKGROUND OF THE INVENTION

1. Field of the Invention

The present general inventive concept relates to an inkjet print head. More particularly, the present general inventive concept relates to an inkjet print head in which inks of an ink storage container are introduced into ink chambers, which receive a predetermined amount of inks, through an ink feed hole.

2. Description of the Related Art

In general, an inkjet print head forms an image having a predetermined color by spraying fine droplets of inks onto a desired position on a printing medium.

Such an inkjet print head may be classified into a thermal-driving type inkjet print head and a piezoelectric-driving type inkjet print head according to the ink spraying mechanism. The thermal-driving type inkjet print head generates bubbles in inks by using a heat source and sprays ink droplets by expansion force of the bubbles.

According to the thermal-driving type inkjet print head, if pulse type current flows in a heater, heat is generated from the heater and inks adjacent to the heater are instantaneously heated at a temperature of about 300° C., so that the inks are boiled to generate bubbles. If the generated bubbles are expanded to apply pressure to the inks filled in an ink chamber, the inks around a nozzle is exhausted in the form of droplets through the nozzle.

As illustrated in FIG. 1, an inkjet print head described in Korean Unexamined Patent Publication No. 2006-0006657 comprises a semiconductor substrate 11, ink chambers 13, ink heaters 14 and nozzles 15. The semiconductor substrate 11 is formed with an ink feed hole 12 to receive inks from an ink storage container (not illustrated). The ink chambers 13 are disposed at both sides of the ink feed hole 12 on the semiconductor substrate 11 in parallel to each other. The ink heaters 14 are provided in the ink chambers 13 to heat the inks of the ink chambers 13, respectively. The nozzles 15 are provided in the ink chambers 13 to spray the inks of the ink chambers 13, respectively.

If such an inkjet print head receives a printing command, the ink heaters 14 instantaneously heat the inks stored in the ink chambers 13. Thus, bubbles are formed in the ink chambers 13 and gradually expanded to apply pressure to the inks of the ink chambers 13, so that the inks of the ink chambers 13 are sprayed through the nozzles 15 by the pressure of the bubbles.

The ink feed hole 12 is formed through the semiconductor substrate 11 to communicate with an ink storage container (not illustrated). The ink feed hole 12 has a rectangular structure as illustrated in FIG. 1.

The ink chambers 13 are disposed at both sides of the ink feed hole 12 and connected to the ink feed hole 12 through fluid paths 16, respectively. The inks stored in the ink storage container are introduced into the semiconductor substrate 11 through the ink feed hole 12 and then supplied to the ink chambers 13 through the fluid paths 16. The ink feed hole 12 serves as a common fluid path for supplying the inks to the fluid paths 16.

According to the inkjet print head as described above, the external air is introduced into the inkjet print head through the nozzles 15 at the time point at which the inks are sprayed, or the air is separated from the inks due to increase in temperature of the inkjet print head, so that air bubbles are formed. Since most air bubbles formed in this way are introduced into the ink storage container through the ink feed hole, they do not exert influence on a printing operation or printing quality.

However, air bubbles generated at the outermost nozzles having a relatively low spraying frequency are gathered at the edges of the ink feed hole, which is roughly formed than any other parts, instead of flowing into the ink storage container. As the inkjet print head is frequently driven, the amount of the air introduced from an exterior or separated from the inks is increased, so that the amount of the air bubbles is increased. Thus, a greater amount of the air bubbles are gathered at the edges of the ink feed hole. The gathered air bubbles block flow of the inks introduced into the ink chambers of the nozzles adjacent to the edges of the ink feed hole, so that the inks may be prevented from being sprayed through the nozzles and the printing quality may deteriorate. Further, current continuously flows in the heaters in a state in which inks are not supplied, so that the heaters may be damaged.

### SUMMARY OF THE INVENTION

Accordingly, the present general inventive concept addresses at least one or more of above-mentioned problems occurring in the related art. The present general inventive concept provides an inkjet print that overcomes various problems caused by air bubbles attached to the edges of an ink feed hole after being generated from the exterior air introduced when inks are sprayed or the air separated from the inks.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an inkjet print head including a substrate formed with an ink feed hole, a chamber layer provided on the substrate, and having ink chambers to receive inks introduced through the ink feed hole and heaters provided in the ink chambers to heat the inks, the ink chambers and the heaters being disposed at a first side and a second side of the ink feed hole in parallel to each other, and a nozzle layer provided on the chamber layer and provided with nozzles to spray the inks of the ink chambers to an exterior, wherein the chamber layer is provided with a dummy chamber and a dummy heater such that air bubbles, which are gathered at a third side, a fourth side, or a third side and a fourth side of the ink feed hole, are pushed toward a center of the first side, a center of the second side, or centers of the first and second sides of the ink feed hole communicating with an ink storage container.

The inkjet print head may also include where the at least one dummy chamber and the at least one dummy heater are disposed corresponding to the third side, the fourth side, or the third side and the fourth side of the ink feed hole.

The inkjet print head may also include where the at least one dummy chamber and the at least one dummy heater are disposed at one or more corners of the third side, the fourth side, or the third side and the fourth side of the ink feed hole having a rectangular shape.

The inkjet print head may also include where the at least one dummy chamber and the at least one dummy heater are disposed at the third side, or the fourth side, or the third side and the fourth side of the ink feed hole such that the at least one dummy chamber and the at least one dummy heater are disposed vertically to an array of the nozzles corresponding to the ink chambers and the heaters.

The inkjet print head may also include where the at least one dummy heater is periodically operated.

The inkjet print head may also include a protection layer disposed on the heaters to protect the heaters.

The inkjet print head may also include an anti-cavitation disposed on the protection layer to protect the heaters from cavitation pressure.

The foregoing and/or other aspects and utilities of the general inventive concept may also be achieved by providing a method of disposing ink on a recording medium with an inkjet print head, the method including heating ink received via an ink feed hole in the ink chambers with heaters, the ink chambers and the heaters being disposed at a first side of the ink feed hole, spraying the ink of the ink chambers to the recording medium with a nozzle, and directing air bubbles gathered at a second side of the ink feed hole towards a center of the first side of the ink feed hole communicating with an ink storage container.

The method may also include where the directing air bubbles further includes periodically operating at least one dummy heater located at the second side to push the air bubbles to the center of the first side of the ink feed hole communicating with an ink storage container.

The foregoing and/or other aspects and utilities of the general inventive concept may also be achieved by providing an inkjet print head including one or more ink chambers to receive ink introduced through an ink feed hole and one or more heaters provided in the ink chambers to heat the inks, the one or more ink chambers and the one or more heaters being disposed at a first side of the ink feed hole, and one or more nozzles to spray the ink of the one or more ink chambers to an exterior, at least one dummy chamber and at least one dummy heater on a second side of the ink feed hole adjacent to the first side, where air bubbles, which are gathered at the second side of the ink feed hole, are pushed toward a center of the first side of the ink feed hole communicating with an ink storage container by the at least one dummy heater.

The inkjet print head may also include where the at least one dummy chamber and the at least one dummy heater are disposed corresponding to the second side of the ink feed hole.

The inkjet print head may also include where the at least one dummy chamber and the at least one dummy heater are disposed at one or more corners of the second side of the ink feed hole.

The inkjet print head may also include where the at least one dummy chamber and the at least one dummy heater are disposed at the second side of the ink feed hole such that the at least one dummy chamber and the at least one dummy heater are disposed vertically to an array of the nozzles corresponding to the one or more ink chambers and the one or more heaters.

The inkjet print head may also include where the at least one dummy heater is periodically operated.

The inkjet print head may also include a protection layer disposed on the one or more heaters to protect the one or more heaters.

The inkjet print head may also include an anti-cavitation disposed on the protection layer to protect the one or more heaters from cavitation pressure.

According to the present general inventive concept, an inkjet print head is provided with dummy ink chambers and dummy heaters such that air bubbles gathered at edges of an ink feed hole can be pushed toward an inner side of the ink feed hole when inks are sprayed. Accordingly, although the air bubbles caused by the external air or the air in the inks are gathered at the edges of an ink feed hole, the air bubbles are forcedly pushed toward the center portion of the ink feed hole communicating with an ink storage container such that the air bubbles can flow into the ink storage container. Thus, the inks can be easily supplied to the ink chambers adjacent to the ends of the ink feed hole, so that missing nozzles can be prevented from being generated.

Further, according to the present general inventive concept, missing nozzles are prevented from being generated, so that the printing quality can be improved.

Furthermore, according to the present general inventive concept, missing nozzles are prevented from being generated, so that electric current can be prevented from being continuously supplied to heaters in a state in which inks are not supplied to the inkjet print head. Thus, the heaters damage can be minimized.

### BRIEF DESCRIPTION OF THE DRAWINGS

The above and other objects, features and utilities of the present general inventive concept will be more apparent from the following detailed description taken in conjunction with the accompanying drawings, in which:

FIG. 1 is a layout view schematically illustrating a conventional inkjet print head;

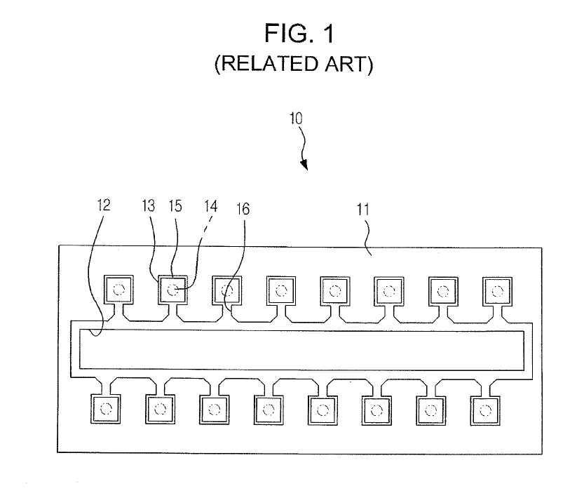

FIG. 2 is a layout view schematically illustrating an inkjet print head according to an embodiment of the present general inventive concept;

FIG. 3 illustrates an exploded perspective view of the inkjet print head illustrated in FIG. 2;

FIG. 4 is a layout view schematically illustrating an inkjet print head according to an embodiment of the present general inventive concept;

FIG. 5 illustrates an exploded perspective view of the inkjet print head illustrated in FIG. 4;

FIG. 6 is a layout view schematically illustrating an inkjet print head according to an embodiment of the present general inventive concept;

FIG. 7 illustrates an exploded perspective view of the inkjet print head illustrated in FIG. 6.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

For convenience of description, an inkjet print head of the present general inventive concept is directed to a thermal-driving type inkjet print head that generates bubbles in inks through a heat source and sprays ink droplets by expansion force of the bubbles.

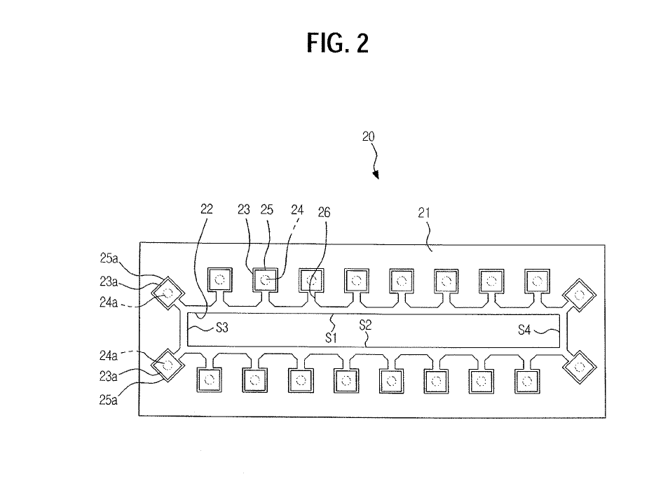

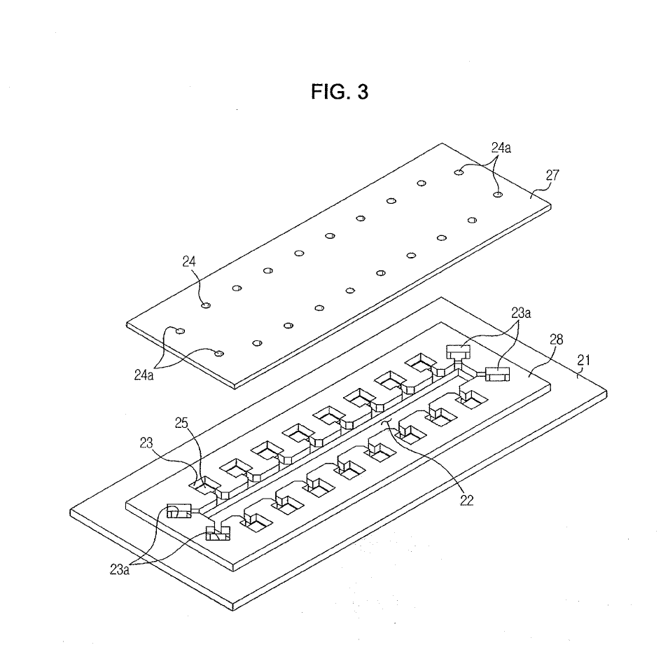

FIG. 2 is a layout view schematically illustrating an inkjet print head according to an embodiment of the present general inventive concept, and FIG. 3 illustrates an exploded perspective view of the inkjet print head illustrated in FIG. 2.

As illustrated in FIGS. 2 and 3, the inkjet print head 20 according to the present embodiment includes a semiconductor substrate 21, a nozzle layer 27 and a fluid-path forming layer 28. The semiconductor substrate 21 is formed with an ink feed hole 22 for receiving inks from an ink storage container (not illustrated). The nozzle layer 27 is installed on the semiconductor substrate 21 and having a plurality of nozzles 24 for spraying the inks. The fluid-path forming layer 28 is interposed between the nozzle layer 27 and the semiconductor substrate 21.

The fluid-path forming layer 28 can include ink chambers 23, heaters 25 and fluid paths 26. The ink chambers 23 receive a predetermined amount of inks introduced through the ink feed hole 22. The heaters 25 spray the inks of the ink chambers 23 toward the nozzles 24. The fluid paths 26 connect the ink feed hole 22 with the ink chambers 23 such that the inks can flow through the ink feed hole 22. Further, the fluid-path forming layer 28 may include a protection layer, which is disposed on the heaters 25 to protect the heaters 25 from the inks, and an anti-cavitation layer disposed on the protection layer to protect the heaters 25 from cavitation pressure.

The ink feed hole 22 is formed through the semiconductor substrate 21 in the longitudinal direction of the semiconductor substrate 21. The ink feed hole 22 communicates with the ink storage container, and has a rectangular structure with sides S1, S2, S3, and S4, as illustrated in FIG. 2.

The ink chambers 23 are aligned at sides S1 and S2 of the ink feed hole 22. The ink chambers 23 are connected to the ink feed hole 22 through the fluid paths 26, respectively. Thus, the inks stored in the ink storage container are introduced into the semiconductor substrate 21 through the ink feed hole 22, and then are supplied to the ink chambers 23 along the fluid paths 26. Accordingly, the ink feed hole 22 serves as a common fluid path to supply the inks to the fluid paths 26.

Dummy chambers 23a, dummy nozzles 24a, and dummy heaters 25a are located corresponding to ends S3 and S4 of the ink feed hole 22. In more detail, the dummy chambers 23a, the dummy nozzles 24a, and the dummy heaters 25a are disposed corresponding to the corners of sides S3 and S4 of the ink feed hole 22. Thus, although air bubbles are gathered at both ends (sides S3 and S4) of the ink feed hole 22 while the inks are being sprayed, the air bubbles are forcedly pushed toward the center portions of sides S1 and S2 of the ink feed hole 22, which communicates with the ink storage container, by bubble pressure generated when the dummy heaters 25a are driven, so that the inks can be easily supplied to the ink chambers 23 on sides S1 and S2 adjacent to both sides S3 and S4 of the ink feed hole 22.

Hereinafter, operations and effects of the inkjet print head having the construction according to present embodiment will be described in detail.

First, if the inkjet print head 20 receives a printing command, the heaters 25 generate heat by supplied power to continuously heat the inks received in the ink chambers 23. Thus, ink bubbles are generated in the ink chambers 23 and are gradually expanded due to the continuous heating to apply pressure to the inks received in the ink chambers 23. Accordingly, a part of the inks received in the ink chambers 23 is sprayed on an external recording paper through the nozzles 24, so that a predetermined image is printed on the recording paper.

However, as described above, the external air is introduced into the inkjet print head 20 through the nozzles 24 at the time point at which the inks are sprayed, or the air is separated from the inks due to increase in temperature of the inkjet print head 20, so that air bubbles are formed.

Since most air bubbles are introduced into the ink storage container through the ink feed hole 22, they do not exert influence on a printing operation or printing quality. However, air bubbles generated at the outermost nozzles 24 (i.e. outermost nozzles on sides S1 and S2 that are adjacent to sides S3 and S4) having a relatively low spraying frequency are gathered at the edges of the ink feed hole 22 (on sides S3 and S4), which is roughly formed than any other parts, instead of flowing into the ink storage container. As the inkjet print head 20 is frequently driven, the amount of the air introduced from an exterior or separated from the inks is increased, so that the amount of the air bubbles is increased more and more. Thus, a greater amount of the air bubbles are gathered at the edges of the ink feed hole 22 on sides S3 and S4. The gathered air bubbles are gradually expanded to block flow of the inks introduced into the ink chambers 23 of the nozzles adjacent to the edges of the ink feed hole 22 on sides S3 and S4, so that the inks may be prevented from being sprayed through the nozzles 24 and the printing quality may deteriorate. Further, current continuously flows in the heaters 25 in a state in which inks are not supplied, so that the heaters 25 may be damaged.

According to the present embodiment, since the dummy chambers 23a, the dummy nozzles 24a, and the dummy heaters 25a are provided corresponding to the corners on sides S3 and S4 of the ink feed hole 22, the dummy heaters 25a can be periodically operated. Thus, although the air bubbles are gathered at the edges of the ink feed hole 22 on sides S3 and S4, the air bubbles are forcedly pushed toward the center portion of sides S1 and S2 of the ink feed hole 22, which communicates with the ink storage container, by bubble pressure such that the air bubbles can flow into the ink storage container. Thus, the inks can be easily supplied to the ink chambers 23 on sides S1 and S2 adjacent to the ends (i.e., sides S3 and S4) of the ink feed hole 22, so that missing nozzles can be prevented from being generated.

According to the present embodiment, the heaters are used as ink spraying devices. However, the present general inventive concept is not limited thereto. In detail, the ink spraying devices may use various devices capable of heating inks received in the ink chambers by using power supplied from an exterior to generate bubbles having a predetermined size, and selectively spraying the inks received in the ink chambers.

Further, according to the present embodiment, the fluid-path forming layer 28 is provided with the dummy chambers 23a and the dummy heaters 25a installed corresponding to the corners of sides S3 and S4 of the ink feed hole 22. In such a case, when the ink feed hole 22 has an increased width, air bubbles gathered at the corners of sides S3 and S4 of the ink feed hole 22 can be pushed toward the center portion of sides S1 and S2 of the ink feed hole 22. However, air bubbles gathered between the corners of sides S3 and S4 with a decreased length may not be easily pushed toward the center portion of sides S1 and S2 of the ink feed hole 22.

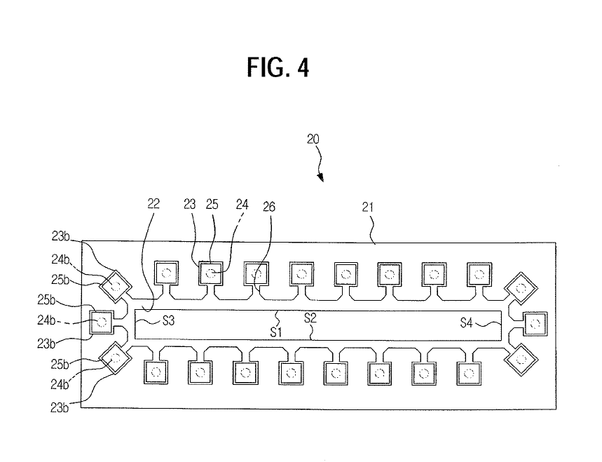

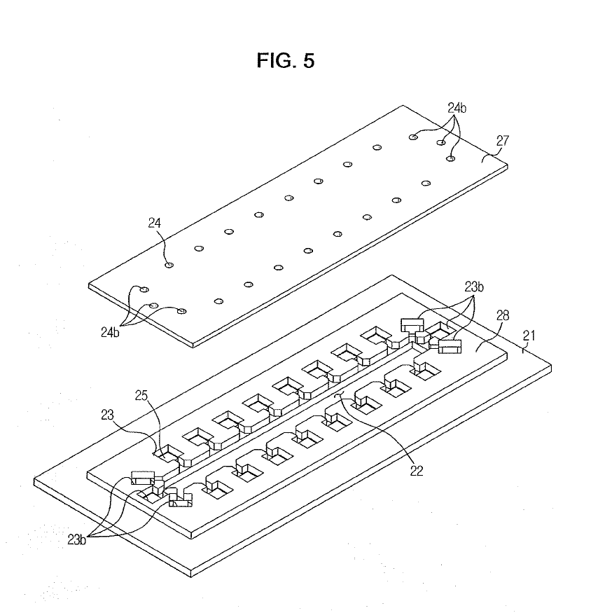

FIG. 4 is a layout view schematically illustrating an inkjet print head according to another embodiment of the present general inventive concept, and FIG. 5 is an exploded perspective view of the inkjet print head illustrated in FIG. 4.

As illustrated in FIGS. 4 and 5, in the inkjet print head according to this embodiment, the fluid-path forming layer 28 is provided with dummy chambers 23b, dummy nozzles 24b, and dummy heaters 25b installed between the corners of the ink feed hole 22 on sides S3 and S4, as well as the dummy chambers 23b, dummy nozzles 24b, and the dummy heaters 25b installed at the corners of sides S3 and S4 of the ink feed hole 22.

Accordingly, air bubbles gathered between the corners of the ink feed hole 22 on sides S3 and S4 can also be pushed toward the center portion of the ink feed hole 22 on sides S1 and S2.

In addition, dummy chambers and dummy heaters may also be provided only between the corners of sides S3 and S4 of the ink feed hole 22 instead of at the corners of sides S3 and S4 of the ink feed hole 22.

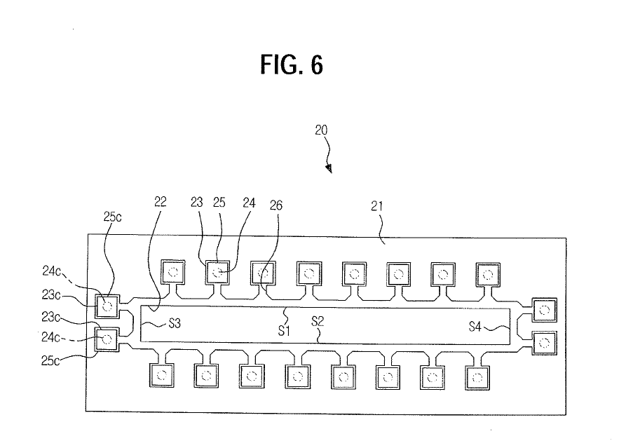

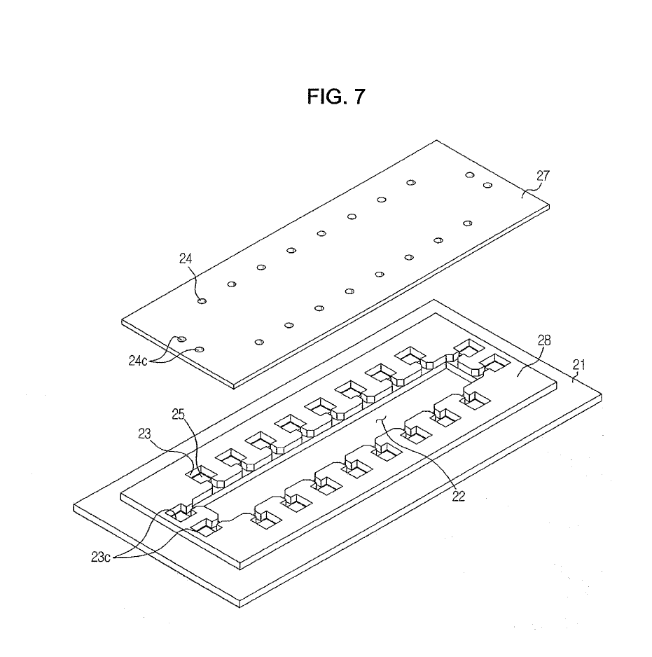

FIG. 6 is a layout view schematically illustrating an inkjet print head according to yet another embodiment of the present general inventive concept, and FIG. 7 is an exploded perspective view of the inkjet print head illustrated in FIG. 6.

As illustrated in FIGS. 6 and 7, the fluid-path forming layer 28 is provided with dummy chambers 23c, dummy nozzles 24c, and dummy heaters 25c installed only between the corners of the ink feed hole 22 instead of the corners on sides S3 and S4 of the ink feed hole 22. At this time, the dummy chambers 23c, dummy nozzles 24c, and the dummy heaters 25c are disposed vertically (i.e., along sides S3 and S4) to the dummy chambers 23 and the dummy heaters 25 aligned at sides S3 and S4 of the ink feed hole 22.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An inkjet print head comprising:
a substrate formed with an ink feed hole;
a chamber layer provided on the substrate, and having ink chambers to receive inks introduced through the ink feed hole and heaters provided in the ink chambers to heat the inks, the ink chambers and the heaters being disposed at a first side and a second side of the ink feed hole in parallel to each other; and
a nozzle layer provided on the chamber layer and provided with nozzles to spray the inks of the ink chambers to an exterior,
wherein the chamber layer is provided with at least one dummy chamber and at least one dummy heater such that air bubbles, which are gathered at a third side, or a fourth side, or the third side and the fourth side of the ink feed hole, are pushed toward a center of the first side, a center of the second side, or centers of the first side and the second side of the ink feed hole communicating with an ink storage container.

2. The inkjet print head of claim 1, wherein the at least one dummy chamber and the at least one dummy heater are disposed corresponding to the third side, the fourth side, or the third side and the fourth side of the ink feed hole.

3. The inkjet print head of claim 2, wherein the at least one dummy chamber and the at least one dummy heater are disposed at one or more corners of the third side, the fourth side, or the third side and the fourth side of the ink feed hole having a rectangular shape.

4. The inkjet print head of claim 2, wherein the at least one dummy chamber and the at least one dummy heater are disposed at the third side, or the fourth side, or the third side and the fourth side of the ink feed hole such that the at least one dummy chamber and the at least one dummy heater are disposed vertically to an array of the nozzles corresponding to the ink chambers and the heaters.

5. The inkjet print head of claim 1, wherein the at least one dummy heater is periodically operated.

6. The inkjet print head of claim 1, further comprising a protection layer disposed on the heaters to protect the heaters.

7. The inkjet print head of claim 6, further comprising an anti-cavitation disposed on the protection layer to protect the heaters from cavitation pressure.

9. A method of disposing ink on a recording medium with an inkjet print head, the method comprising:
heating ink received via an ink feed hole in chambers with heaters, the ink chambers and the heaters being disposed at a first side of the ink feed hole;
spraying the ink of the ink chambers to the recording medium with a nozzle; and
directing air bubbles gathered at a second side of the ink feed hole towards a center of the first side of the ink feed hole communicating with an ink storage container.

10. The method of claim 9, wherein the directing air bubbles further comprises:
periodically operating at least one dummy heater located at the second side to push the air bubbles to the center of the first side of the ink feed hole communicating with an ink storage container.

11. An inkjet print head comprising:
one or more ink chambers to receive ink introduced through an ink feed hole and one or more heaters provided in the ink chambers to heat the inks, the one or more ink chambers and the one or more heaters being disposed at a first side of the ink feed hole; and
one or more nozzles to spray the ink of the one or more ink chambers to an exterior;
at least one dummy chamber and at least one dummy heater on a second side of the ink feed hole adjacent to the first side;
wherein air bubbles, which are gathered at the second side of the ink feed hole, are pushed toward a center of the first side of the ink feed hole communicating with an ink storage container by the at least one dummy heater.

12. The inkjet print head of claim 11, wherein the at least one dummy chamber and the at least one dummy heater are disposed corresponding to the second side of the ink feed hole.

13. The inkjet print head of claim 12, wherein the at least one dummy chamber and the at least one dummy heater are disposed at one or more corners of the second side of the ink feed hole.

14. The inkjet print head of claim 12, wherein the at least one dummy chamber and the at least one dummy heater are disposed at the second side of the ink feed hole such that the at least one dummy chamber and the at least one dummy heater are disposed vertically to an array of the nozzles corresponding to the one or more ink chambers and the one or more heaters.

15. The inkjet print head of claim 11, wherein the at least one dummy heater is periodically operated.

16. The inkjet print head of claim 11, further comprising:
a protection layer disposed on the one or more heaters to protect the one or more heaters.

17. The inkjet print head of claim 16, further comprising:
an anti-cavitation disposed on the protection layer to protect the one or more heaters from cavitation pressure.
